(19) United States
(12) Patent Application Publication
(10) Pub. No.: US 2011/0241504 A1
(43) Pub. Date: Oct. 6, 2011

(54) SYSTEMATIC PANEL FURNITURE AND A MANUFACTURING METHOD OF PANELS THEREOF

(76) Inventor: Xiaozhong XU, Qingdao (CN)

(21) Appl. No.: 13/162,571

(22) Filed: Jun. 16, 2011

Related U.S. Application Data
(63) Continuation-in-part of application No. PCT/CN2009/001411, filed on Dec. 10, 2009.

(30) Foreign Application Priority Data
Dec. 31, 2008 (CN) 200910013613.8

(51) Int. Cl. A47B 87/00; B23P 17/04

(52) U.S. Cl. 312/111; 29/428

(57) ABSTRACT

The systematic panel furniture includes panels and connectors. The panels include side panel, isolation panel, door panel, and drawer panel. A plurality of systematic holes is formed in the side panel. A plurality of front row mounting holes and back row mounting holes are formed in the isolation panel. The systematic holes include a plurality of front row systematic holes and back row systematic holes. Each hole spacing is 32n mm, and n is an integer number. The distance between the centers of the front row mounting holes in the isolation panel and the front edge of the isolation panel is w mm. The vertical size of the drawer panel is 32n−r mm. The vertical size of the door panel is 32 nk−r mm, where w is a positioning parameter value, n is an integral number, k is an integral number, and r is a tolerance value.

### CROSS-REFERENCE TO RELATED APPLICATIONS

This application is a continuation-in-part of PCT International Application of application number: PCT/CN2009/001411, with an international filing date of Dec. 10, 2009, now pending, and claims the priority benefit of Chinese application serial number: 200910013613.8, filed on Dec. 31, 2008. The contents of each of the above-mentioned patent applications is hereby incorporated by reference herein in its entirety and made a part of this specification.

### FIELD OF INVENTION

The invention relates to a production technology of a panel furniture, especially relates to a systematic panel furniture and a manufacturing method of panels or similar furniture parts of the systematic panel furniture.

### BACKGROUND OF THE INVENTION

In the beginning of last century, the usage of the engineered wood as the building materials came with the industrial revolution in Europe. From that time, people had been trying to apply it into the field of furniture manufacturing and performed research and development for this purpose. In 1960, a Germany vendor, Hettich Group, invented a steel concealed hinge and registered it as the 32 mm system. From this moment on, the engineered wood is used popularly in the furniture manufacturing industry, and hence forms is an emerging and modern industry, i.e. a panel furniture industry. Henceforth, a new manufacturing mode is born in the traditional furniture industry and rapidly stepped into the stage of industrialization. After forty years of development, the manufacture of the panel furniture has become more mature. The manufacturing apparatus, the accompanying hardware accessories, and the raw and auxiliary materials thereof correspondingly have all become mature and standardized, and this creates a favorable condition for the panel furniture industry to enter into the stage of systematic design, allowing for improved conditions for standardized manufacturing.

However, some restricting factors still existed in the development of the panel furniture industry. Due to lack of knowledge for industrial design in the panel furniture, many companies in the panel furniture industry are still having difficulty in obtaining a systematic design that incorporates the entire development cycle having stages for research & development, product manufacturing, and sale & service. Therefore, the panel furniture industry has failed to increase productivity and service level to fulfill the needs of the consumers sufficiently because of the lack of systematic considerations to the factors that include the increase of material utilization, parts standardization, product yield, flexibility in parts compatibility, and functional diversity.

Thus, in order to overcome the issues and problems of traditional panel furniture, an new systematic panel furniture and a manufacturing method of panels thereof is provided herein.

### SUMMARY OF THE INVENTION

One aspect of the invention is to provide a systematic panel furniture and manufacturing method of panels thereof in order to modify the conventional method in research & development, the existing cumbersome manufacturing process, and the traditional sales & service adopted in the conventional panel furniture industry.

The invention can be realized by the following described technical features. The systematic panel furniture includes a plurality of panels and connectors. The panels include a side panel, and an isolation panel. The panels may further include a door panel, and a drawer panel. A plurality of systematic connecting structures, such as systematic holes is formed in the side panel. A plurality of front row mounting holes and back row mounting holes are formed in the isolation panel. The systematic holes include a plurality of front row systematic holes and back row systematic holes. Each hole spacing, i.e. the distance between the centers of each two adjacent holes, is 32n mm, and n is an integral or integer number. In other words, the center of each systematic hole is located in a mesh having a grid interval of 32 mm, and the center of each mounting hole is located in another mesh having the grid interval of 32 mm. A plurality of connectors are configured to connect the side panels and the isolation panels together. The connectors are hinges or eccentric adjusters from Hettich (a famous German company), or any type of connectors which can connect the side panels and the isolation panels together.

The length b of the isolation panels and the distance between two side panels are identical, and is set as 32n+2f, f is the distance from the connecting point of the connector connected on the isolation panel to the end of the connector closed to the side panel, and n is an integral number. In other words, in connection conditions, the connector has two connecting points. The first connecting point is connected to the isolation panel and the second connecting point is connected to the side panel, such that the side panels and the isolation panels are connected together with the connector. In addition, the connector has two ends in connection direction, wherein the first end is closed to the isolation panel and the second end is closed to the side panel. f is the distance from the first connecting point to the second end.

In practice, f is determined by the structure of the connector itself. If the type of the connector is determined, f is determined, and a series of lengths b of the isolation panels are determined which are identical with the distance between two side panels.

For example, if n is assumed to be a series of numbers such as 10, 12, 15, 18, 20, 25, and 30, and if f is 10 mm, the manufacturer produces a series of isolation panels with 340 mm, 404 mm, 500 mm, 596 mm, 660 mm, 840 mm and 980 mm lengths. A client requires panel furniture with 700 mm width (corresponding to the length of the isolation panels) and with four interlayer spaces for his studying room. The manufacturer provides three side panels, ten isolation panels with 340 mm length, and a plenty of connectors. Three side panels are disposed at equal interval, and isolation panels are disposed between every two side panels. Every two isolation panels are disposed at the same level, so the width of the furniture is the lengths of two isolation panels (680 mm) plus the thicknesses of three side panels (approximate 700 mm). As long as n is selected properly, a series of panels are formed. A combination of the panels can adapt most of the furniture spaces easily.

The distances of a top edge and a bottom edge of the side panel from the centers of their respective adjacent systematic holes are d−m, respectively, d is the thickness of the isolation panel, and m is the difference in vertical connecting distances of the connector. In the ten isolation panels, the top surface of a first pairs of isolation panels is on a level with the top edges of the side panels. The bottom surface of a fifth pairs of isolation panels can also be on a level with the bottom edges of the side panels. The dimension optimal design of the panels improves the standardization of furniture manufacturing observably.

The door panel belongs to an exterior covering structure type or an embedded structure type. Embedded structure type is the door that is flush with the side panel, and exterior covering structure type is the door that is covered on edges of the side panel. The distance between the centers of the front row mounting holes in the isolation panel and the front edge of the isolation panel is w. When the door panel and the drawer panel belong to the exterior covering structure type, the distance between the centers of the front row systematic holes in the side panel and the front edge of the isolation panel is w. When the door panel and the drawer panel belong to the embedded structure type, the distance between the centers of the front row systematic holes in the side panel and the front edge of the isolation panel is the sum of w and the distance between the front edge of the side panel and the front edge of the isolation panel. The vertical size of the drawer panel is 32n−r mm. The vertical size of the door panel is 32 nk−r, where w is a positioning parameter value, n is an integral number, k is an integral number, and r is a tolerance value. The units of w and r are both in mm. The value of w can be set to be 37 mm according to the conventional general international standard of hinge accessories mounting.

The value of k is usually corresponding to the actual height of the drawer panel. In general, the value of k in the same system is a multiple of 2, for instance: 2, 4, 6, 8, 12 and a sequence of numbers obtained in a similar fashion. When the height of the draw panel is larger, the value of k in the same system is a multiple of 1, for instance: 1, 2, 3, 4 and a sequence of numbers obtained in a similar fashion. When the height of the draw panel is smaller, the value of k in the same system is a multiple of 3, for instance: 3, 6, 9, 12 and a sequence of numbers obtained in a similar fashion.

The exterior covering structure referred to in the present invention is defined as having the front edges of the side panel and the isolation panel aligned with the inner surface of the door panel or the drawer panel. The embedded structure referred to in the present invention is defined as having the front edge of the side panel higher than the inner surface of the door panel or the drawer panel.

Based upon the positioning parameter, after the position of the front row systematic holes is determined, because the distances between the front row systematic holes and the back row systematic holes in the side panel and the isolation panel are 32n mm, thus, the position of the back row systematic holes can be determined, where n is an integral number. The mounting holes in the isolation panel are each corresponding to the systematic holes in the side panels.

The distances of the top edge and the bottom edge from the centers of their respective adjacent systematic holes are d−m, respectively, where d is the thickness of the isolation panel and m is the difference in vertical connecting distances of an connector, and the difference in vertical connecting distances of the connector is defined as the difference in the vertical distance of the connecting point of the connector and the isolation panel to the vertical distance of the connecting point of the connector and the side panel in this application. The distances of the left edge and the right edge from the centers of their respective adjacent mounting holes in the isolation panel are f, respectively, where f is the horizontal distance between the connecting center and the connecting end of the connector mounted on the isolation panel. After the values of the isolation panel thickness d and the difference in vertical connecting distances m are determined based upon design and manufacturing requirements, the sizes of the panels and the processing positions are determined.

During the drilling process for forming a plurality of handle mounting holes in the drawer panel or door panel upon requiring, in order to keep up with the consistent industrial production of the furniture system, the positioning parameter should be selected as being preferably w, i.e. the distance between the center of the handle mounting holes and the adjacent edge of the panels is w. The value of w is usually set to be 37 mm.

The vertical size of the side panel is 32n+2(d−m), where d is the thickness of the isolation panel and m is the difference in vertical connecting distances of the connector. Using the Hettich Group's standard of hardware accessories of furniture as an example, the difference in vertical connecting distances of the selected connectors can be 6, 7, 7.5, 8, 9.5, 11, 14.5, where 6 and 8 are more commonly used. The distance between the two ends of the isolation panel is 32n+2f, where f is the distance between the hole center and the connecting end of the connector.

When the drawer panel belongs to the exterior covering structure type, the horizontal size or dimension of the drawer panel is b+e−r. When the drawer panel belongs to the embedded structure type, the horizontal size of the drawer panel is b−r, where b is the length of the isolation panel, e is the thickness of the side panel, and r is the tolerance value.

In an example of a single door being placed above or below the drawer, the horizontal size of the door panel is b+e−r when the horizontal size of the door panel is identical to that of the drawer panel, i.e. the door panel belongs to the exterior covering structure type; the horizontal size of the door panel is b−r when the door panel belongs to the embedded structure type. In another example of a double door being placed above or below the drawer, the horizontal size of the door panel is (b+e)÷2−r when the door panel belongs to the exterior covering structure type; the horizontal size of the door panel is b÷2−r when the door panel belongs to the embedded structure type. The aforesaid b is the length of the isolation panel, e is the thickness of the side panel, and r is the tolerance value.

The value of r, i.e. the tolerance value, is determined according to the setting of the tolerance value in the product design step. In the actual production step, each panel must be processed under a plurality of processing procedures including panel cutting, panel sealing, hole drilling, hardware accessories assembling, combining together, and installation. The absolute values of average errors are usually not smaller than 0.2 mm in each step due to the influences of the errors from machining and manual installation. Therefore, the set tolerance value r is usually larger than 2 mm and smaller than the thickness of the isolation panel. The value of r can be an integer number or a number with decimal points, but is preferably to be an integer number. In order to achieve the height standardization of the panel, the set values of r are preferably kept consistent. For example, when the vertical size of the drawer panel is 32n−3, this represents that the set tolerance value is 3, accordingly, the vertical size of the door panel is set to be 32k−3 and the value of r of the drawer panel and the door panel in the horizontal direction is correspondingly set to be 3.

In the embodiment where the value of r is 3 mm, the distance between the centers of hinge mounting holes of the door panel and the edge of the door panel is 32n+13+d−m, where n is an integral number, d is the thickness of the isolation panel, m is the difference in vertical connecting distances of the connector (i.e. when the side panel and the isolation panel is connected by the connector, the vertical distance between the center of systematic hole of the side panel and the center of mounting hole of the isolation panel. the difference in vertical connecting distances is defined by the connector itself), 13 is calculated by the following expressions: 32(n+0.5)+d−m−r. The distances between the centers of the hinge mounting holes and the adjacent side edge of the door panel are determined according to the height of a hinge base and the thickness of the door panel, respectively, and the distance is ranged from 20.5 to 28.5. The height difference between the top edge of the door panel and the top surface of the corresponding isolation panel is the set tolerance value r, i.e. the top edge of the door panel is lower than the top surface of the corresponding isolation panel for r, in units of mm. The bottom edge of the door panel is parallel and level with the top surface of the corresponding isolation panel. The hinge mounting holes are usually drilled by a hinge slotting machine, and the processing of the hinge mounting holes and the handle mounting hole is usually done twice until completion, for this reason, the distance between the centers of the hinge mounting holes and the centers of the handle mounting holes is not specifically limited.

A manufacturing method of the panels of the systematic panel furniture is provided in the present invention. The method includes steps for panel cutting, edge sealing, and hole drilling. In the hole drilling step, a positioning parameter of the front row mounting holes is set to be w, i.e. the distance between the centers of the front row mounting holes and the front edge of the isolation panel is w. When the door panel or drawer panel belongs to the exterior covering structure type, the positioning parameter of the front row mounting holes is w, i.e. the distance between the centers of the front row systematic holes and the front edge of the side panel is w. When the door panel or drawer panel belongs to the embedded structure type, the positioning parameter of the front row mounting holes is the sum of w and the distance between the front edge of the side panel and the front edge of the isolation panel, i.e. the distance between the centers of the front row systematic holes and the front edge of the side panel is the sum of w and the distance between the front edge of the side panel and the front edge of the isolation panel. By adopting the positioning parameter in the hole drilling step, consistent quality of the panel processing is maintained and the mass production of the panels is realized.

The aforesaid value of w, i.e. the positioning parameter value, should be a fixed value, but the value can be chosen from a selection. In view of the requirement of the location of the hole of the conventional hinge base, the value of w should be set to be 37 mm.

To determine the size of the panels of the furniture, those skilled in the art should refer to the averaged panel cutting parameters and the complementary panel cutting parameters from a panel cutting parameter table (described in the following contents below) under the condition of abiding by the above calculation requirements.

One benefit of the present invention is that all of the panels of the systematic furniture meet the requirements of the standardization and systematic production of the panel furniture, so as to achieve the results of maximization of the material utilization for finished products, the manufacturing and processing systemization, and high degree of standardization of the panels. Any material used in the manufacture of the panel furniture and the corresponding standardized accessories, plastic material, and hardware accessories can be used in the present invention. Therefore the flexibility of the functions, forms, and styles of the furniture products can be enhanced even when using only a limited number of required panels. By adopting of the systematic furniture of the present invention, the following described benefits can be achieved. First, design simplification is achieved and processing of the panel furniture leads to greater diversity and more choices in the forms and styles. The user can assemble the panel furniture more freely according to their need, fully achieving personalization and having more freedom in forming different combinations of the panel furniture. Second, the material utilization for finished products is increased as a result of the optimized panel cutting parameters of the present invention. Furthermore, the processing cost in the manufacturing process can be greatly reduced because each panel is highly standardized. Third, the efficiency of production is highly improved. The standardization of the product specification in the present invention brings about the higher material usage in the finished product. By the height standardization of the panels, mass production of the panel furniture can be achieved and the manufacturing efficiency can be greatly improved, so as to make the management of production enterprises more orderly.

### BRIEF DESCRIPTION OF THE DRAWINGS

FIG. 1 is a schematic diagram of a side panel which is corresponding to a door panel or a drawer panel of an exterior covering structure type.

FIG. 2 is a schematic diagram of a side panel which is corresponding to a door panel or a drawer panel of an embedded structure type.

FIG. 3 is a schematic diagram of an isolation panel on which an connector (category number: VB35) made by Hettich Group is mounted.

FIG. 4 is a schematic diagram of an isolation panel on which an connector (category number: VB35) made by Hettich Group is mounted.

FIG. 5 is a schematic diagram of a drawer panel of the exterior covering structure type.

FIG. 6 is a schematic diagram of a drawer panel of the embedded structure type.

FIG. 7 is a schematic diagram of a door panel of a single door when the single door is corresponding to the drawer panel of the exterior covering structure type.

FIG. 8 is a schematic diagram of a door panel of a double door when the double door is corresponding to the drawer panel of the exterior covering structure type.

FIG. 9 is a schematic diagram of a door panel of a single door when the single door is corresponding to the drawer panel of the embedded structure type.

FIG. 10 is a schematic diagram of a door panel of a double door when the double door is corresponding to the drawer panel of the embedded structure type.

FIG. 11 is a schematic diagram of a cabinet of a first embodiment.

FIG. 12 is a schematic diagram of a cabinet of a second embodiment.

FIG. 13 is a schematic diagram of a cabinet of a third embodiment.

FIG. 14 is a schematic diagram of a cabinet of a fourth embodiment.

FIG. 15 is a schematic diagram of a cabinet of a fifth embodiment.

FIG. 16 is a schematic diagram of a cabinet of a sixth embodiment.

FIG. 17 is a schematic diagram of a cabinet of a seventh embodiment.

FIG. 18 is a schematic diagram of a cabinet of an eighth embodiment.

FIG. 19 is a schematic diagram of a cabinet of a ninth embodiment.

FIG. 20 is a schematic diagram of a cabinet of a tenth embodiment.

FIG. 21 is a schematic diagram of a cabinet of an eleventh embodiment.

FIG. 22 is a schematic diagram of a cabinet of a twelfth embodiment.

FIG. 23 is a schematic diagram of a cabinet of a thirteenth embodiment.

FIG. 24 is a schematic diagram of a cabinet of a fourteenth embodiment.

### DETAILED DESCRIPTION OF THE INVENTION

A systematic panel furniture is provided in the present invention. The systematic panel furniture includes a plurality of panels and connectors. The panels include a side panel, an isolation panel, a door panel, and a drawer panel. The isolation panel includes a top panel, a bottom panel, a drawer panel, and other horizontal connecting panels. The system also includes some functional components. The functional components are the components included in the furniture that has a specific function, for instance: the body of a drawer, a pants rack, and other independent component having a specific function.

The door panel or the drawer panel belongs to an exterior covering structure type or an embedded structure type. The exterior covering structure type referred to in the present invention is defined as having the front edges of the side panel and the isolation panel aligned with the inner surface of the door panel or the drawer panel. The embedded structure type referred to in the present invention is defined as having the front edge of the side panel higher than the inner surface of the door panel or the drawer panel. A plurality of systematic holes is formed in the side panel. The systematic holes are the open holes formed in the panel, and are used for mounting, connecting, positioning, or the adjusting of the height of the isolation panel. The systematic holes include a plurality of front row systematic holes and back row systematic holes. A plurality of mounting holes for the connectors is formed in the isolation panel. The mounting holes include a plurality of front row mounting holes and a plurality of back row mounting holes. The hole spacings of the systematic holes and the mounting holes for the connectors are both 32n, where n is an integral number. In other words, the center of each systematic hole and the center of the each mounting hole are located in the meshes having a grid interval of 32 mm. The features of the invention will be better understood from the following description, when taken together with the accompanying drawing. The connector in this embodiment is the connector made by Hettich Group whose category number is VB35 or VB 36.

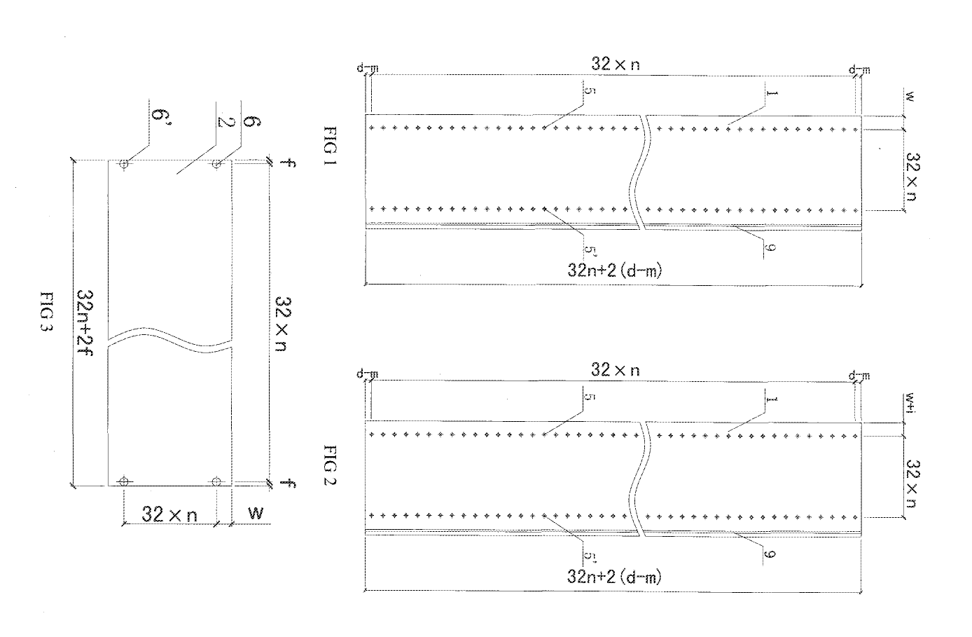

As shown in FIG. 1, a side panel 1 is shown. A plurality of systematic holes formed in the side panel is divided into a plurality of front row systematic holes 5 and a plurality of back row systematic holes 5′. The centers of the front row systematic holes 5 and that of the back row systematic holes 5′ are located in the meshes having the grid interval of 32 mm. The interval between the back row systematic holes and the front systematic holes is 32n mm. The distances of the top edge and the bottom edge from the centers of their respective adjacent systematic holes are d−m, respectively. The vertical size of the side panel is 32n+2(d−m), where d is the thickness of an isolation panel and m is the difference in vertical connecting distances of an connector. The difference in vertical connecting distances of the selected connector can be set to be 6, 7, 7.5, 8, 9.5, 11, 14.5, where 6 and 8 are more commonly used. The systematic holes in the side panel belong to a blind hole type or a through hole type. When the systematic holes belong to the through hole type, the location of the systematic holes on the outside surface of the side panel is corresponding to the location of the systematic holes on the inside surface. A connecting trough 9 is formed along the vertical direction of the side panel, and is used for mounting the back panel. The back panel can be directly inserted into the connecting trough 9. When the door panel or drawer panel belongs to an exterior covering structure type, the positioning parameter of the front row mounting holes is set to be w, i.e. the distance between the centers of the front row systematic holes and the edge of the side panel is w, where w is a positioning parameter value. As shown in FIG. 2, when the door panel or drawer panel is the embedded structure type, the positioning parameter of the front row mounting holes is the sum of w and the distance between the front edge of the side panel 1 and the front edge of the isolation panel, i.e. the sum of w and the distance between the front edge of the side panel and the front edge of the isolation panel, namely w+i shown in the figure.

An isolation panel shown in FIG. 3 can be used for installing an connector made by Hettich Group (category number: VB35). A plurality of mounting holes in the isolation panel can be divided into a plurality of front row mounting holes 6 and a plurality of back row mounting holes 6′. The mounting holes are used for mounting the connector; and the center of each hole is located on the meshes having the grid interval of 32 mm. A positioning parameter of the front row mounting holes is set to be w, i.e. the distance between the centers of the front row mounting holes and the front edge of the isolation panel is w, where w is a positioning parameter value. The distance of the left edge and the right edge of the isolation panel 2 from the centers of their respective adjacent mounting holes are f, respectively. The distance between the two ends of the isolation panel 2 is 32n+2f, where f is the distance between the hole center and the connecting end of the connector.

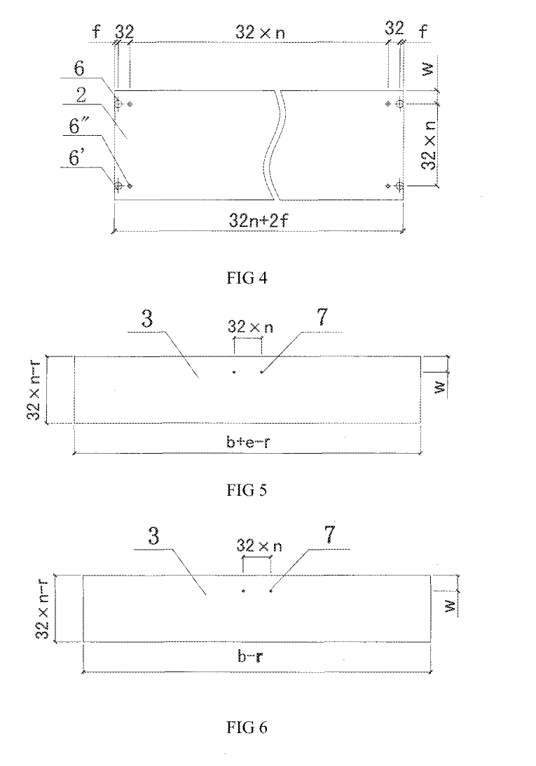

An isolation panel 2 shown in FIG. 4 is used for mounting an connector made by Hettich Group (category number: VB36). Compared with the isolation panel shown in FIG. 3, the isolation panel 2 shown in FIG. 4 further includes a plurality of locating holes 6″. The hole spacing between the mounting holes 6 and the locating holes 6″ is 32 mm (the hole spacing value is determined from the structure of the connector of Hettich Group (category number: VB36)). Therefore, the center of each hole is located on the mesh having the grid interval of 32 mm.

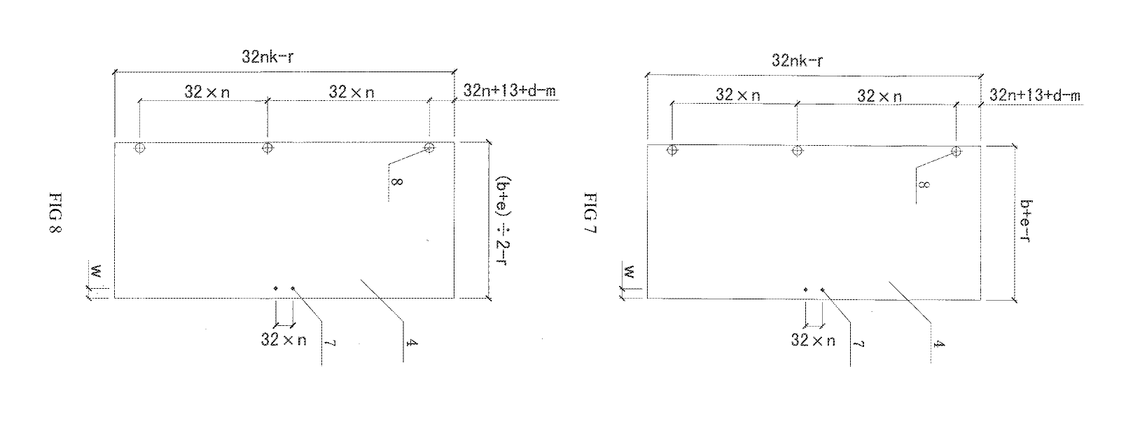

A plurality of handle mounting holes 7 is formed in a drawer panel 3 shown in FIG. 5. The interval between the handle mounting holes 7 is 32n, where n is an integral number. In order to realize the mass production of the panels, the positioning parameter of the handle mounting holes 7 is set to be w, i.e. the distance between the centers of the handle mounting holes 7 and the adjacent edge of the side panel is w, where w is a positioning parameter value. The vertical size of the drawer panel 3 is 32n−r, where n is an integral number. When the drawer panel belongs to the exterior covering structure type, the horizontal size of the drawer panel is b+e−r. Please refer to FIG. 6, when the drawer panel is the embedded structure type, the horizontal size of the drawer panel is b−r, where b is the length of the isolation panel, e is the thickness of the side panel, and r is the tolerance value.

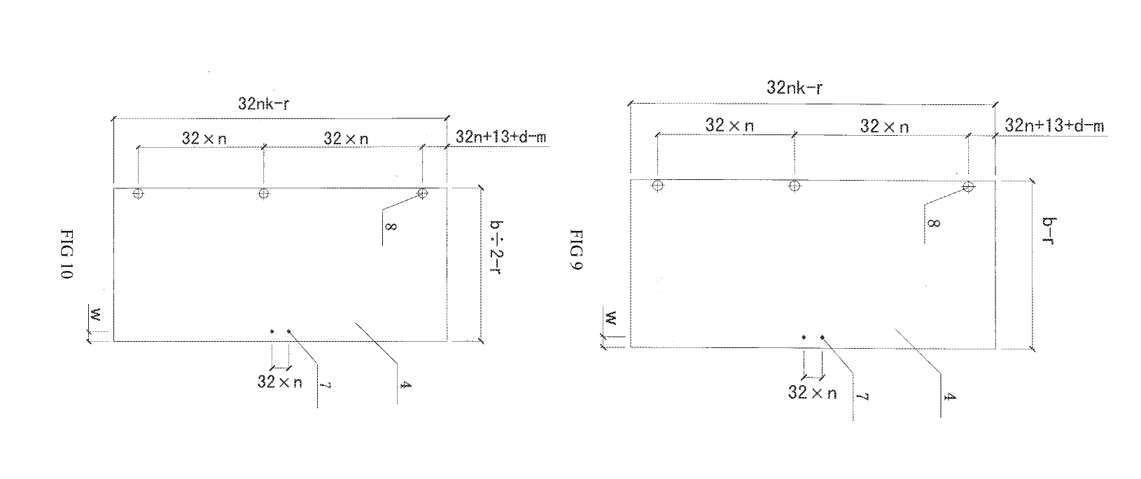

A plurality of handle mounting holes 7 and a plurality of hinge mounting holes 8 are formed in a door panel 4 shown in FIG. 7. The hole spacing between each handle mounting hole 7 is 32n mm and the hole spacing between each handle mounting hole 8 is also 32n mm, where n is an integral number. Because the hinge mounting hole 8 is usually drilled by a hinge slotting machine, the distance between the center of the handle mounting hole 7 and the center of the hinge mounting hole 8 is not specifically limited. In order to realize the industrial mass production of the panels and the drilling for forming a plurality of the handle mounting holes 7, the positioning parameter of the handle mounting holes 7 is also set to be w, i.e. the distance between the centers of the handle mounting holes 7 and the adjacent edge of the side panel is w, where w is a positioning parameter value. The height of the door panel 4 is determined according to the height of the drawer panel. Namely, when the vertical size of the drawer panel is 32n−r mm, the vertical size of the door panel is 32nk−r mm, where w is a positioning parameter value, n is an integral number, and k is an integral number. The value of k is usually corresponding to the actual height of the drawer panel. In general, the value of k in the same system is a multiple of 2, for instance: 2, 4, 6, 8, 12 and a sequence of numbers obtained in a similar fashion. When the height of the draw panel is larger, the value of k in the same system is a multiple of 1, for instance: 1, 2, 3, 4 and a sequence of numbers obtained in a similar fashion. When the height of the draw panel is smaller, the value of k in the same system is a multiple of 3, for instance: 3, 6, 9, 12 and a sequence of numbers obtained in a similar fashion. The horizontal size of the door panel 4 is determined according to the horizontal size of the drawer panel when the door panel belongs to an exterior covering structure type. When a single door is placed above or below the drawer, the horizontal size of the door panel is identical to that of the drawer panel, i.e. b+e−r. Please refer to FIG. 8, when a double door is placed above or below the drawer, the horizontal size of the door panel is (b+e)÷2−r, where b is the length of the isolation panel, e is the thickness of the side panel, and r is the tolerance value. In order to ensure the standardization of the panels, the height difference between the top edge of the door panel and the top surface of the corresponding isolation panel is the tolerance value r set by the system. The bottom edge of the door panel 4 are parallel and level with the top surface of the isolation panel. When the door panel is the embedded structure type as shown in FIG. 9 and the single door is placed above or below the drawer, the horizontal size of the door panel is identical to that of the drawer panel, i.e. b−r. Please refer to FIG. 10. When the double door is placed above or below the drawer, the horizontal size of the door panel is b+2−r, where b is the length of the isolation panel and r is the tolerance value.

The handle mounting holes 7 of the door panel 4 can be formed not only in the middle location as shown in the figure, but also in other locations. During the processing, the drilling is carried out in all pre-determined locations for the handle mounting holes. The depth of the handle mounting holes is limited to between 1˜2 mm from the surface of the door panel, i.e. the holes are blind holes. The handle can be mounted according to the need of the user. The distance between the centers of the hinge mounting holes 8 and the top edge of the door panel is 32n+13+d−m (under the condition that the value of r is equal to 3 mm), so as to ensure match between large and small door panels during the product modification, and the orderliness and consistency of the match between the door panel and the drawer panel. When the distance from the hinge mounting hole in the top end to the top edge of the door panel is not equal to the distance from the hinge mounting hole in the bottom end to the bottom edge of the door panel, the type of the door panel will be divided into a left door panel type and a right door panel type. When the difference between the distance from the top edge of the door panel to its adjacent hinge mounting hole and the distance from the bottom edge of the door panel to its adjacent hinge mounting hole is smaller than 2 mm, and due to the vertical adjusting range ±2 of the base of the hinge in general, the entire hinge mounting holes can be moved up or down so as to make the distance of the whole hinge mounting holes from the top edge be equal to that from the bottom edge. The difference between the actual numbers after the adjustment and the numerical calculation before the adjustment is about 0.5˜1, but it will not affect the alignment requirement during the combination of the furniture and the mounting of the door panel. By the aforesaid processing method of the handle mounting holes and the hinge mounting holes, the type of the door panel is prevented from being divided into the left door panel type and the right door panel type, thus enhancing the versatility and interchangeability of the door panel and achieving the high degree of standardization of the door panel.

The distance between the centers of the mounting holes and the adjacent edge of the door panel is determined according to the height of the base of the hinge and the thickness of the door panel. The distance can be set to be between 20.5 and 28.5.

A manufacturing method of the panel of the systematic panel furniture is provided in the present invention. The method includes steps for panel cutting, panel sealing, and hole drilling. In the hole drilling, a positioning parameter of the front row mounting holes is set to be w, i.e. the distance between the centers of the front row mounting holes and the front edge of the isolation panel is w. When the door panel or drawer panel belongs to an exterior covering structure type, the positioning parameter of the front row mounting holes is w, i.e. the distance between the centers of the front row systematic holes and the edge of the side panel is w. When the door panel or drawer panel belongs to the embedded structure type, the positioning parameter of the front row mounting holes is the sum of w and the distance between the front edge of the side panel and the front edge of the isolation panel, i.e. the distance between the centers of the front row systematic holes and the edge of the side panel is the sum of w and the distance between the front edge of the side panel and the front edge of the isolation panel, where w is the positioning parameter value. The positioning parameter is used for ensuring that the location standard of the holes of the panels are all the same and that the drillings for forming the holes can be accomplished in one time, no matter how many holes there are. The panels of different sizes can be processed just by mounting the corresponding drill bit and without adjusting machine, so as to improve the drilling efficiency. To determine the size of the panels of the furniture, the skill in the art should refer to the average panel cutting parameters and the complementary panel cutting parameters from the panel cutting parameter table as well as abiding by the above calculation requirements, so as to maximize material utilization for finished products.

The following tables list the panel cutting parameters for panels of different specifications. A formula for defining the average panel cutting parameters is (x−4c−12)÷(c+1).

unit: mm

| | | |
|---|---|---|
| Numbers | Average | |
| of | panel | |
| cuttings | cutting | |
| (c) | parameters | Complementary panel cutting parameters |

Panel cutting parameter table for 4 × 8 feet panel

| | | | | | | | | | | |
|---|---|---|---|---|---|---|---|---|---|---|
| 1220 | 0 | 1208 | | | | | | | | |
| (x) | 1 | 602 | 602 | | | | | | | |
| | 2 | 400 | 804 | 400 | | | | | | |
| | 3 | 299 | 905 | 602 | 299 | | | | | |
| | 4 | 238.4 | 965.6 | 723.2 | 480.8 | 238.4 | | | | |
| | 5 | 198 | 1006 | 804 | 602 | 400 | 198 | | | |
| | 6 | 169.1 | 1034.6 | 861.5 | 688.4 | 515.3 | 342.2 | 169.1 | | |
| | 7 | 147.5 | 1056.5 | 905 | 753.5 | 602 | 450.5 | 299 | 147.5 | |
| | 8 | 130.7 | 1073.6 | 938.9 | 804.2 | 669.5 | 534.8 | 400.1 | 265.4 | 130.7 |
| | . . . | . . . | . . . | . . . | . . . | . . . | . . . | . . . | . . . | . . . |
| 2440 | 0 | 2428 | | | | | | | | |
| (x) | 1 | 1212 | 1212 | | | | | | | |
| | 2 | 806.7 | 1617.4 | 806.6 | | | | | | |
| | 3 | 604 | 1820 | 1212 | 604 | | | | | |
| | 4 | 482.4 | 1941.6 | 1455.2 | 968.8 | 482.4 | | | | |
| | 5 | 401.3 | 2022.5 | 1617.2 | 1211.9 | 806.6 | 401.3 | | | |
| | 6 | 343.4 | 2080.4 | 1733 | 1385.6 | 1038.2 | 690.8 | 343.4 | | |
| | 7 | 300 | 2124 | 1820 | 1516 | 1212 | 908 | 604 | 300 | |
| | 8 | 266.2 | 2157.6 | 1887.4 | 1617.2 | 1347 | 1076.8 | 806.6 | 536.4 | 266.2 |
| | . . . | . . . | . . . | . . . | . . . | . . . | . . . | . . . | . . . | . . . |

Panel cutting parameter table for 5 × 8 feet panel

| | | | | | | | | | | |
|---|---|---|---|---|---|---|---|---|---|---|
| 1525 | 0 | 1513 | | | | | | | | |
| (x) | 1 | 754.5 | 754.3 | | | | | | | |
| | 2 | 501.7 | 1007.4 | 501.7 | | | | | | |
| | 3 | 375.3 | 1133.9 | 754.6 | 375.3 | | | | | |
| | 4 | 299.4 | 1209.6 | 906.2 | 602.8 | 299.4 | | | | |
| | 5 | 248.8 | 1264 | 1007.2 | 754.4 | 501.6 | 248.8 | | | |
| | 6 | 212.7 | 1296.2 | 1079.5 | 862.8 | 646.1 | 429.4 | 212.7 | | |
| | 7 | 185.6 | 1323.2 | 1133.6 | 944 | 754.4 | 564.8 | 375.2 | 185.6 | |
| | 8 | 164.6 | 1344.8 | 1176.2 | 1007.6 | 839 | 670.4 | 501.8 | 333.2 | 164.6 |
| | . . . | . . . | . . . | . . . | . . . | . . . | . . . | . . . | . . . | . . . |
| 2440 | 0 | 2428 | | | | | | | | |
| (x) | 1 | 1212 | 1212 | | | | | | | |
| | 2 | 806.7 | 1617.4 | 806.6 | | | | | | |
| | 3 | 604 | 1820 | 1212 | 604 | | | | | |
| | 4 | 482.4 | 1941.6 | 1455.2 | 968.8 | 482.4 | | | | |
| | 5 | 401.3 | 2022.5 | 1617.2 | 1211.9 | 806.6 | 401.3 | | | |
| | 6 | 343.4 | 2080.4 | 1733 | 1385.6 | 1038.2 | 690.8 | 343.4 | | |
| | 7 | 300 | 2124 | 1820 | 1516 | 1212 | 908 | 604 | 300 | |
| | 8 | 266.2 | 2157.6 | 1887.4 | 1617.2 | 1347 | 1076.8 | 806.6 | 536.4 | 266.2 |
| | . . . | . . . | . . . | . . . | . . . | . . . | . . . | . . . | . . . | . . . |

Panel cutting parameter table for 6 × 8 feet panel

| | | | | | | | | | | |
|---|---|---|---|---|---|---|---|---|---|---|
| 1830 | 0 | 1818 | | | | | | | | |
| (x) | 1 | 907 | 907 | | | | | | | |
| | 2 | 603.3 | 1210.6 | 603.3 | | | | | | |
| | 3 | 451.5 | 1362.5 | 907 | 451.5 | | | | | |
| | 4 | 360.4 | 1453.6 | 1089.2 | 724.8 | 360.4 | | | | |
| | 5 | 299.7 | 1514.5 | 1210.8 | 907.1 | 603.4 | 299.7 | | | |
| | 6 | 256.3 | 1557.8 | 1297.5 | 1037.2 | 776.9 | 516.6 | 256.3 | | |
| | 7 | 223.8 | 1590.6 | 1362.8 | 1135 | 907.2 | 679.4 | 451.6 | 223.8 | |
| | 8 | 198.4 | 1615.2 | 1412.8 | 1210.4 | 1008 | 805.6 | 603.2 | 400.8 | 198.4 |
| | . . . | . . . | . . . | . . . | . . . | . . . | . . . | . . . | . . . | . . . |
| 2440 | 0 | 2428 | | | | | | | | |
| (x) | 1 | 1212 | 1212 | | | | | | | |
| | 2 | 806.7 | 1617.4 | 806.6 | | | | | | |
| | 3 | 604 | 1820 | 1212 | 604 | | | | | |
| | 4 | 482.4 | 1941.6 | 1455.2 | 968.8 | 482.4 | | | | |
| | 5 | 401.3 | 2022.5 | 1617.2 | 1211.9 | 806.6 | 401.3 | | | |
| | 6 | 343.4 | 2080.4 | 1733 | 1385.6 | 1038.2 | 690.8 | 343.4 | | |
| | 7 | 300 | 2124 | 1820 | 1516 | 1212 | 908 | 604 | 300 | |
| | 8 | 266.2 | 2157.6 | 1887.4 | 1617.2 | 1347 | 1076.8 | 806.6 | 536.4 | 266.2 |
| | . . . | . . . | . . . | . . . | . . . | . . . | . . . | . . . | . . . | . . . |

Panel cutting parameter table for 6 × 10 feet panel

| | | | | | | | | | | |
|---|---|---|---|---|---|---|---|---|---|---|
| 1830 | 0 | 1818 | | | | | | | | |
| (x) | 1 | 907 | 907 | | | | | | | |
| | 2 | 603.3 | 1210.6 | 603.3 | | | | | | |
| | 3 | 451.5 | 1362.5 | 907 | 451.5 | | | | | |
| | 4 | 360.4 | 1453.6 | 1089.2 | 724.8 | 360.4 | | | | |
| | 5 | 299.7 | 1514.5 | 1210.8 | 907.1 | 603.4 | 299.7 | | | |
| | 6 | 256.3 | 1557.8 | 1297.5 | 1037.2 | 776.9 | 516.6 | 256.3 | | |
| | 7 | 223.8 | 1590.6 | 1362.8 | 1135 | 907.2 | 679.4 | 451.6 | 223.8 | |
| | 8 | 198.4 | 1615.2 | 1412.8 | 1210.4 | 1008 | 805.6 | 603.2 | 400.8 | 198.4 |
| | . . . | . . . | . . . | . . . | . . . | . . . | . . . | . . . | . . . | . . . |
| 3050 | 0 | 3038 | | | | | | | | |
| (x) | 1 | 1517 | 1517 | | | | | | | |
| | 2 | 1010 | 2024 | 1010 | | | | | | |
| | 3 | 756.5 | 2277.5 | 1517 | 756.5 | | | | | |
| | 4 | 604.4 | 2429.6 | 1821.2 | 1212.8 | 604.4 | | | | |
| | 5 | 503 | 2531 | 2024 | 1517 | 1010 | 503 | | | |
| | 6 | 430.6 | 2603.6 | 2169 | 1734.4 | 1299.8 | 865.2 | 430.6 | | |
| | 7 | 376.2 | 2657.4 | 2277.2 | 1897 | 1516.8 | 1136.6 | 756.4 | 376.2 | |
| | 8 | 334 | 2700 | 2362 | 2024 | 1686 | 1348 | 1010 | 672 | 334 |
| | . . . | . . . | . . . | . . . | . . . | . . . | . . . | . . . | . . . | . . . |

Panel cutting parameter table for 6 × 12 feet panel

| | | | | | | | | | | |
|---|---|---|---|---|---|---|---|---|---|---|
| 1830 | 0 | 1818 | | | | | | | | |
| (x) | 1 | 907 | 907 | | | | | | | |
| | 2 | 603.3 | 1210.6 | 603.3 | | | | | | |
| | 3 | 451.5 | 1362.5 | 907 | 451.5 | | | | | |
| | 4 | 360.4 | 1453.6 | 1089.2 | 724.8 | 360.4 | | | | |
| | 5 | 299.7 | 1514.5 | 1210.8 | 907.1 | 603.4 | 299.7 | | | |
| | 6 | 256.3 | 1557.8 | 1297.5 | 1037.2 | 776.9 | 516.6 | 256.3 | | |
| | 7 | 223.8 | 1590.6 | 1362.8 | 1135 | 907.2 | 679.4 | 451.6 | 223.8 | |
| | 8 | 198.4 | 1615.2 | 1412.8 | 1210.4 | 1008 | 805.6 | 603.2 | 400.8 | 198.4 |
| | . . . | . . . | . . . | . . . | . . . | . . . | . . . | . . . | . . . | . . . |
| 3660 | 0 | 3648 | | | | | | | | |
| (x) | 1 | 1822 | 1822 | | | | | | | |
| | 2 | 1213.3 | 2430.6 | 1213.3 | | | | | | |
| | 3 | 909 | 2735 | 1822 | 909 | | | | | |
| | 4 | 726.4 | 2917.6 | 2187.2 | 1456.8 | 726.4 | | | | |
| | 5 | 604.7 | 3039.5 | 2430.8 | 1822.1 | 1213.4 | 604.7 | | | |
| | 6 | 517.7 | 3126.2 | 2604.5 | 2082.8 | 1561.1 | 1039.4 | 517.7 | | |
| | 7 | 452.5 | 3191.5 | 2735 | 2278.5 | 1822 | 1365.5 | 909 | 452.5 | |
| | 8 | 401.8 | 3242.4 | 2836.6 | 2430.8 | 2025 | 1619.2 | 1213 | 808 | 401.8 |
| | . . . | . . . | . . . | . . . | . . . | . . . | . . . | . . . | . . . | . . . |

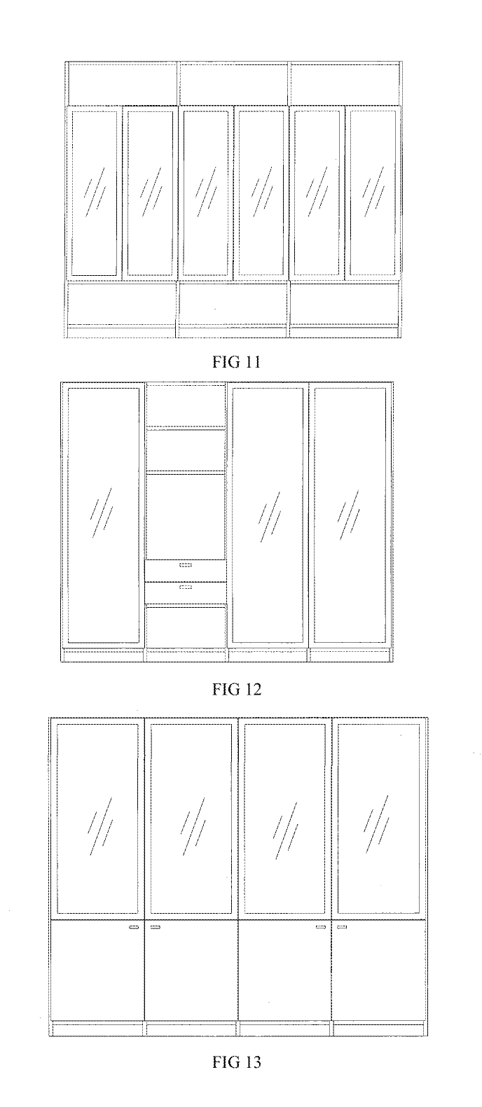

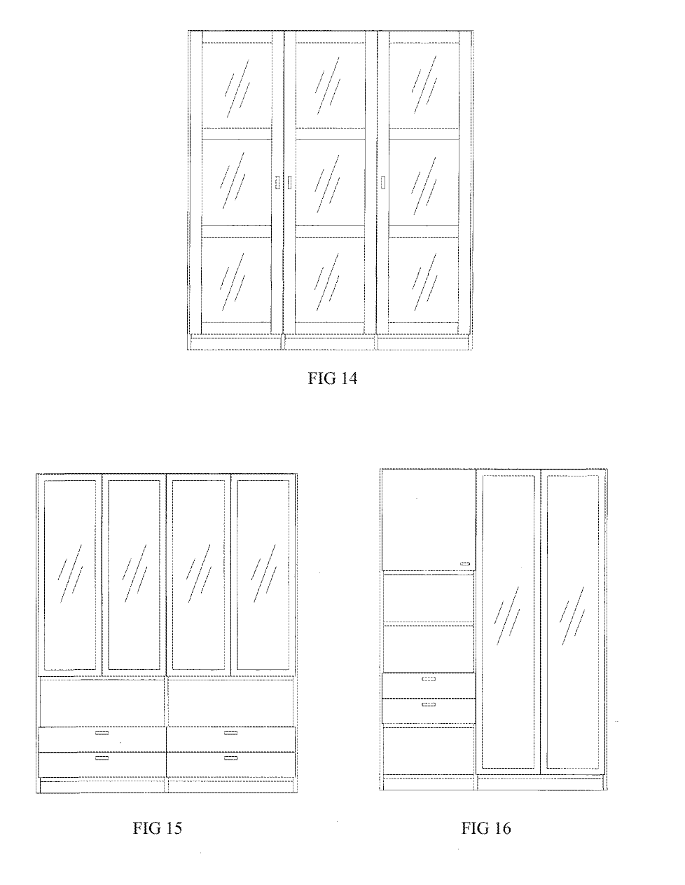

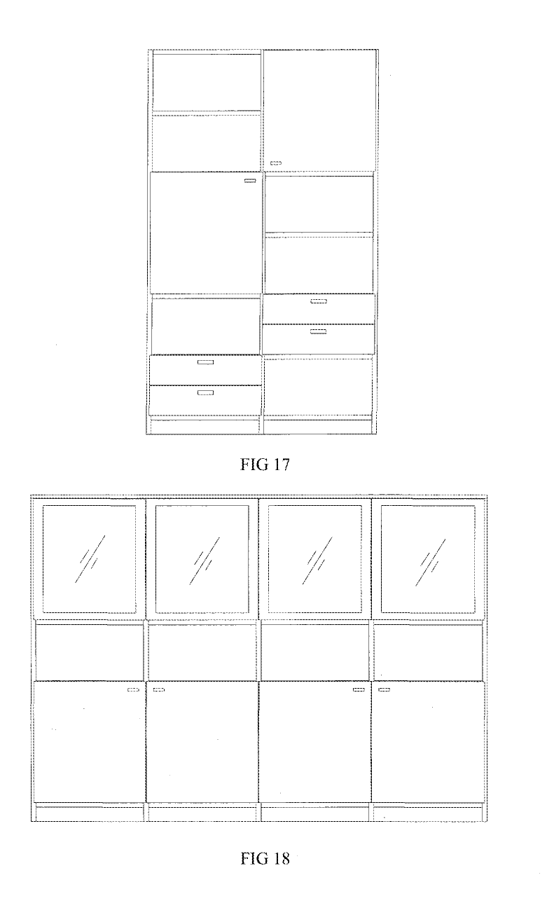

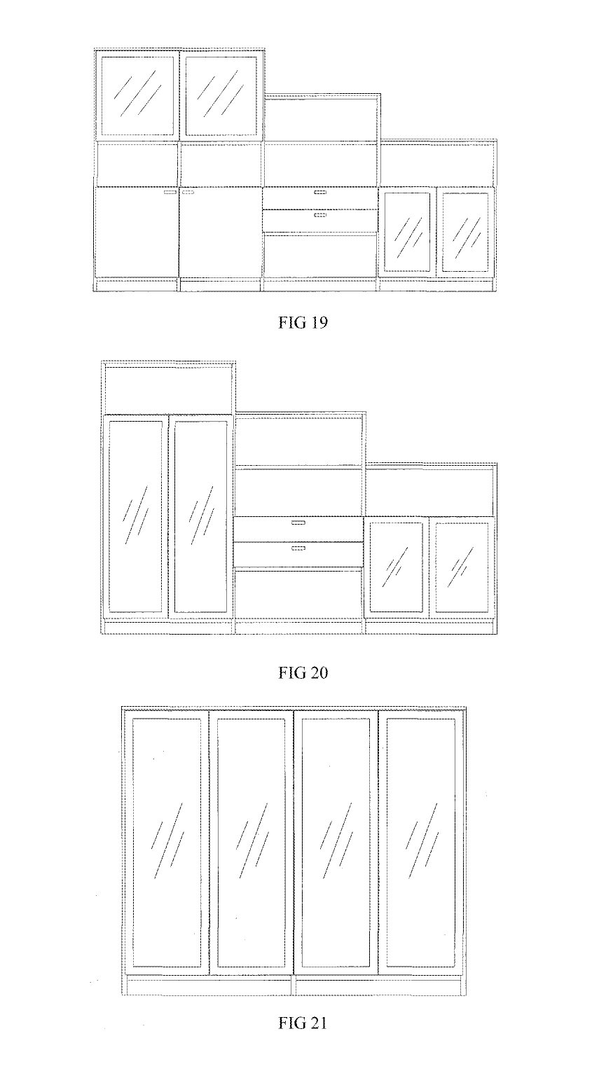

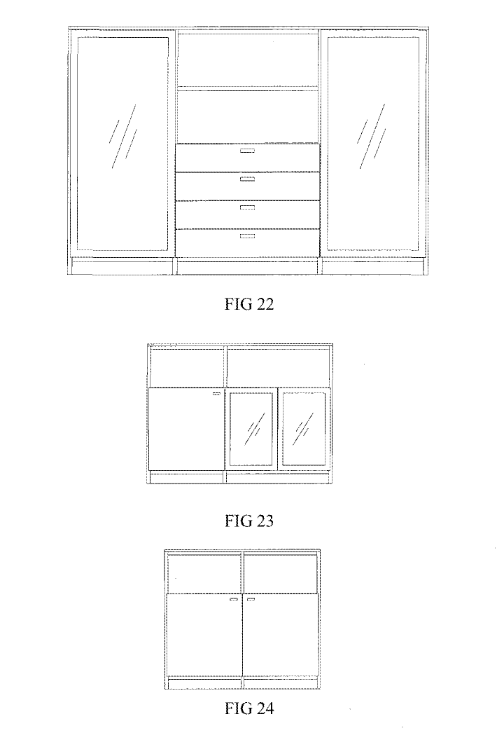

The features of the invention will be described in more detail in the following description of the accompanying specific values. First, some parameter values of the panels are set. The value of the positioning parameter is set to be 37 mm, the thickness of the side panel is set to be 25 mm, the thickness of the side panel is set to be 25 mm, the thickness of the isolation panel is set to be 25 mm, the thickness of the drawer panel is set to be 16 mm, the thickness of the door panel is set to be 16 mm, and the tolerance value is set to be 3 mm. The connector mounted on the isolation panel is made by Hettich Group, and its category number is VB35. The difference in vertical connecting distances of the connector is set to be 8 mm. The distance between the hole center and the connecting end of the connector is 9.5 mm. By performing a calculation based upon the aforesaid setting value and the technical features in the present invention, the value of the height of the side panel can be set to be 2338, 2018, 1698, 1378, 1058, 738, or 418 mm, the width of the side panel is set to be 316 mm. The length of the isolation panel can be set to be 787 mm or 563 mm and the width thereof is set to be 298 mm. The height of the door panel can be set to be 637, 1277, and 1917 mm and the horizontal size or dimension thereof can be set to be 585 or 403 mm. The horizontal size of the drawer panel can be set to be 809 or 585 and the height thereof is 157 mm. The hinge mounting holes and the handle mounting holes are formed in the door panel. The hole spacing between the handle mounting holes is 64 mm. The distance between the top edge of the door panel and the centers of the adjacent hinge holes should be set to be 94 according to a calculation based upon the technical features in the present invention, and by performing this calculation, the distance between the bottom edge of the door panel and the centers of the adjacent hinge holes should be set to be 95 mm. In order to prevent the type of door panel from being divided into left door panel and right door panel, the entire hinge mounting holes should be moved down 0.5 according to the processing method of the hinge mounting holes in the present invention, so that the distances between top edge, the bottom edge of the door panel and their respective adjacent holes are both 94.5 mm. By the above different sizes of panels, the user can assemble the panel furniture shown in FIG. 11 to FIG. 24 and other type thereof, thus achieving the structural variety of the panel furniture. Furthermore, even without the modification of the specification of size, the variation of the materials having different texture can add to the variety of the panel furniture and achieve the mass production of the panels of the panel furniture.

The units of the sizes in the present invention are all in millimeter.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. A systematic panel furniture, comprising:
a plurality of panels, the panels comprising a plurality of side panels and a plurality of isolation panels, the side panels disposed at the two sides of the isolation panels and the isolation panels disposed between the side panels;
a plurality of eccentric connectorconnectors, the eccentric connectorconnectors configured to connect the side panels and the isolation panels together;
wherein a plurality of systematic connecting structures are formed from the top to the bottom in the side wall, the distances between all adjacent systematic connecting structures are 32n mm, respectively, the eccentric connectorconnectors are penetrated through the systematic connecting structures so as to connect the isolation panels to the side panels, the length b of the isolation panels and the distance between two side panels are identical, and is set as 32n+2f, f is the distance from the connecting point of the connector connected on the isolation panel to the end of the connector closed to the side panel f is the distance from the connecting point of the eccentric connector and the isolation panel to the connecting point of the eccentric connector and the side panel, and n is an integral number.

2. The systematic panel furniture of claim 1, wherein the systematic connecting structures are a plurality of systematic holes, the systematic holes comprises a plurality of front row systematic holes and a plurality of back row systematic holes, a plurality of mounting holes are formed in the isolation panels, the distance between the front row systematic holes and the back row systematic holes, having a height corresponding to the front row systematic holes, is 32n mm, and n is an integral number.

3. The systematic panel furniture of claim 2, wherein the distances of a top edge and a bottom edge of the side panel from the centers of their respective adjacent systematic holes are d−m, respectively, d is the thickness of the isolation panel, and m is the difference in vertical connecting distances of the eccentric connectorconnector.

4. The systematic panel furniture of claim 3, further comprising:
a door panel, the vertical size of the door panel being equal to 32nk−r, wherein n is an integral number, k is an integral number, and r is a tolerance value.

5. The systematic panel furniture of claim 4, further comprising:
a drawer panel, the vertical size of the drawer panel being equal to 32n−r, wherein n is an integral number and r is a tolerance value.

6. The systematic panel furniture of claim 5, wherein the horizontal size of the door panel is identical to the horizontal size of the drawer panel when a single door is placed above or below a drawer, the horizontal size of the door panel is b+e−r when the door panel belongs to an exterior covering structure type, or the horizontal size of the door panel is b−r when the door panel belongs to an embedded structure type, in which b is the length of the isolation panel, e is the thickness of the side panel, and r is a tolerance value.

7. The systematic panel furniture of claim 5, wherein the horizontal size of the door panel is identical to the horizontal size of the drawer panel when a double door is placed above or below a drawer, the horizontal size of the door panel is (b+e)÷2−r when the door panel belongs to an exterior covering structure type, or the horizontal size of the door panel is b÷2−r when the door panel belongs to an embedded structure type, in which b is the length of the isolation panel, e is the thickness of the side panel, and r is a tolerance value.

8. The systematic panel furniture of claim 7, wherein the value of r is larger than 2 and smaller than the thickness of the isolation panel.

9. The systematic panel furniture of claim 7, wherein the distance between the edge of the door panel and the center of a mounting hole for a hinge bore is 32n+(32(n+0.5)+d−m−r)13+d−m, in which d is the thickness of the isolation panel, r is a tolerance value, and m is the difference in vertical connecting distances of the eccentric connectorconnector.

10. A manufacturing method of a systematic panel furniture, the method comprising steps for panel cutting, edge sealing, and hole drilling, wherein in the drilling step, the positioning parameter of the front row mounting holes is w; when the door panel or the drawer panel belongs to the exterior covering structure type, the positioning parameter of the front row systematic holes of the side panel is w; when the door panel or the drawer panel belongs to the embedded structure type, the positioning parameter of the front row systematic holes of the side panel is the sum of w and the distance between the front edge of the side panel and the front edge of the isolation panel, and w is a positioning parameter value.
